(19) United States
(12) Patent Application Publication
(10) Pub. No.: US 2009/0163177 A1
(43) Pub. Date: Jun. 25, 2009

(54) Guest Communication and Information Delivery User Interface

(75) Inventors: Steven Clarke Bearden, Hingham, MA (US); Alvin W. Lee, Cambridge, MA (US); John P. Burke, Walpole, MA (US)

Correspondence Address: PROSKAUER ROSE LLP, ONE INTERNATIONAL PLACE, BOSTON, MA, 02110, US

(73) Assignee: FMR LLC, Boston, MA (US)

(21) Appl. No.: 11/962,148

(22) Filed: Dec. 21, 2007

(51) Int. Cl. H04Q 7/20

(52) U.S. Cl. 455/412.1; 455/456.2

(57) ABSTRACT

Described are computer-based methods and apparatuses, including computer program products, for providing a user interface for guest communication and information delivery. The user interface is provided on a computing device located in, for example, a guest's hotel room. The computing device is part of a system that can include internal and external networks, webportals, e-mail modules, document modules, and information storage modules. The guest uses the user interface to perform tasks that might otherwise require multiple resources. Guests may make telephone calls, send electronic messages, receive electronic messages, have electronic messages received by the hotel forwarded to other e-mail addresses, browse the Internet, and/or retrieve information on hotel services using the same computing device.

### FIELD OF THE INVENTION

The present invention relates generally to computer-based methods and apparatuses, including computer program products, for providing a user interface for guest communication and information delivery.

### BACKGROUND

Hotel guests utilize a wide variety of information and services during their stays. Guests may be interested in matters as diverse as local weather forecasts, sporting events, entertainment, transportation options to airports, spa treatments, e-mail access, and web browsing. Guests read printed booklets in their hotel rooms to learn about in-room dining options, treatments offered by the on-site spa, and the fitness center's hours. Guests call room service for late night snacks and the front desk for directions and shuttle options to airports. Guests use their own laptops to connect to the Internet. Sometimes, guests lose their plane tickets and need to track down a printing center to obtain another boarding pass. As such, guests spend a great amount of time contacting multiple resources to obtain the information and services they need.

### SUMMARY OF THE INVENTION

One approach to guest communication and information delivery is through a computerized method. The method includes providing a user interface. Through the user interface, a guest accesses information based on a location associated with a computing device. The user interface is used to initiate a telephone call from a first telephone device based on a telephone call request entered into a separate computing device. The user interface is used to send a modified electronic message to a first network. The first electronic message address in the modified electronic message is replaced with a second electronic message address.

Another approach to guest communication and information delivery is through a computer program product. The computer program product is tangibly embodied in an information carrier. The computer program product includes instructions being operable to cause a data processing apparatus to provide a user interface. Through the user interface, a guest accesses information based on a location associated with a computing device. The user interface is used to initiate a telephone call from a first telephone device based on a telephone call request entered into a separate computing device. The user interface is used to send a modified electronic message to a first network. The first electronic message address in the modified electronic message is replaced with a second electronic message address.

Another approach to guest communication and information delivery is through a system. The system includes a user interface. The user interface is configured to permit a guest to access information based on a location associated with a computing device. The user interface is further configured to initiate a telephone call from a first telephone device based on a telephone call request entered into a separate computing device. The user interface is further configured to send a modified electronic message to a first network. The first electronic message address in the modified electronic message is replaced with a second electronic message address.

Another approach to guest communication and information delivery is through a system. The system includes a means for providing a user interface. The system further includes a means for permitting a guest to access information based on a location associated with a computing device. The system further includes a means for initiating a telephone call from a first telephone device based on a telephone call request entered into a separate computing device. The system further includes a means for sending to a first network a modified electronic message whose first electronic message address has been replaced with a second electronic message address.

In some examples, any of the approaches above can include one or more of the following features. Information is accessed through a web portal. The first electronic message address is associated with a hotel, the second electronic message address is associated with a business different from the hotel, and the guest is associated with the business and a room in the hotel.

In other examples, the first electronic message address for the guest is created based on a location associated with a computing device and information associated with the guest, and the first electronic message address is assigned solely to the guest. An e-mail module associated with the computing device receives a reply to the modified electronic message that includes the first electronic message address, and the reply and second electronic message address are associated based on the assignment of the first electronic mail address to the guest. The e-mail module forwards the reply to the second electronic mail address based on information associated with the guest.

In some examples, the computing device is associated with the first telephone device based on location information associated with the computing device and location information associated with the first telephone device, and a telephone call request is sent to a second network associated with the first telephone device. A telephone call between the first and second telephone devices is initiated based on the telephone call request from the computing device.

In other examples, location information associated with the computing device is a first room assignment in a hotel, location information associated with the first telephone device is a second room assignment in a hotel, and the first and second rooms are the same.

In some examples, information is based on one or more guest preferences. Guest preferences can be contact information, email information, electronic message address, web access information, weather information, security information, dining information, visitor information, emergency information, default appointments, telephone number, and/or geographic information.

In other examples, one or more guest preferences associated with the guest are stored in an information storage module. Information can be help information, phone information, web information, preference information, destination information, guest service information, message information, service directory information, hotel feature information, Internet information, wireless information, security information, emergency information, meeting guide information, and/or weather information.

In other examples, the computing device is in a hotel room, dorm room, rental unit, temporary housing unit, and/or patient hospital room. The computing device and first telephone device are in the same physical location. Information associated with the guest is removed from the computing device.

In some examples, a map is displayed which is customized based on the location of the computing device, the location of the first telephone device, information inputted by the guest, and/or information inputted by an entity administrating the web portal.

An advantage of the user interface is that the guest can access a variety of information and services while traveling without his/her own technology devices. Another advantage is that telephone, e-mail, and web browsing capabilities are consolidated into one centralized device for use by the guest. An additional advantage is that stored preferences enable user interfaces to be automatically customized whenever a guest checks into the hotel a second or subsequent time. Another advantage is that guests can send e-mails with personal contact information from third party accounts without missing responses after he/she checks out of the hotel. Other aspects and advantages of the present invention will become apparent from the following detailed description, taken in conjunction with the accompanying drawings, illustrating the principles of the invention by way of example only.

### BRIEF DESCRIPTION OF THE DRAWINGS

The foregoing and other objects, features, and advantages of the present invention, as well as the invention itself, will be more fully understood from the following description of various embodiments, when read together with the accompanying drawings.

FIG. 1 is a functional block diagram of a system illustrating telephone and information storage and retrieval functions.

FIG. 2 is a functional block diagram of a system illustrating electronic messaging and document storage, retrieval, and transmittal functions.

FIG. 3 is an exemplary welcome screenshot of an exemplary user interface.

FIG. 4 is an exemplary preferences screenshot of an exemplary user interface.

FIG. 5 is an exemplary services directory listing screenshot of an exemplary user interface.

FIG. 6 is an exemplary speed-dial screenshot of an exemplary user interface.

FIG. 7 is an exemplary telephone screenshot of an exemplary user interface.

FIG. 8 is an exemplary electronic messages screenshot of an exemplary user interface.

FIG. 9 is an exemplary flowchart depicting the processing of a telephone call request.

FIG. 10 is an exemplary flowchart depicting the processing of an electronic mail request.

### DETAILED DESCRIPTION

In general overview, a user interface for guest communication and information delivery is provided to guests at a hotel. The user interface is provided on computing devices in hotel rooms, and the computing devices are connected to a network within the hotel. Guests can use the user interface to perform a variety of tasks that might otherwise require multiple resources. Guests may make telephone calls, send electronic messages, receive electronic messages, have electronic messages received by the hotel forwarded to other e-mail addresses, browse the Internet, and/or retrieve information on hotel services using the same computing device. Although exemplified through use in a hotel, the user interface can also be used in places such as dormitories, rental complexes, temporary housing complexes, and/or hospitals.

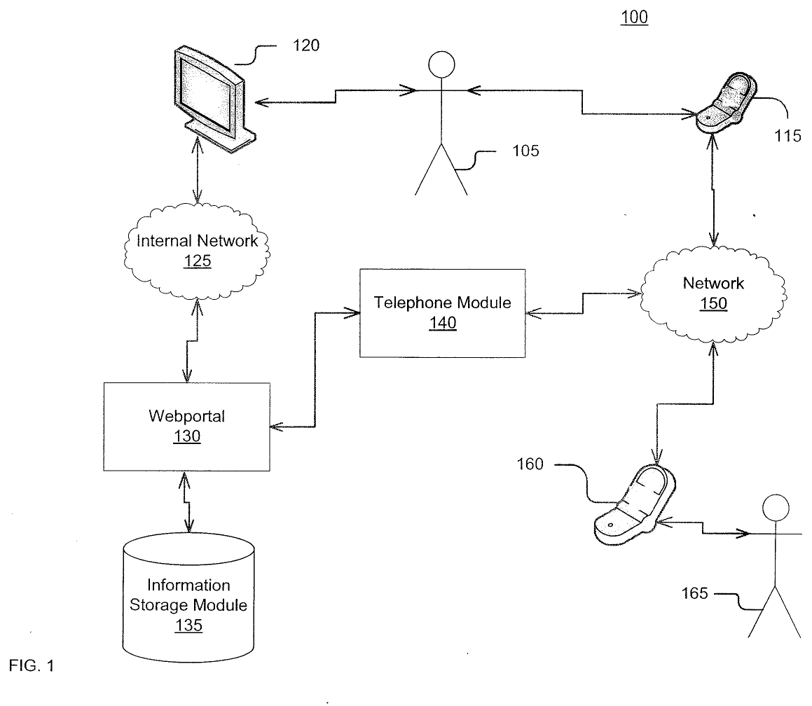

FIG. 1 is a functional block diagram of an exemplary system 100 illustrating telephone and information storage and retrieval functions. The system 100 includes a computing device 120, a telephone device 115, an internal network 125, a webportal 130, an information storage module 135, a telephone module 140, and a network 150. The computing device 120 and the telephone device 115 are in the same physical location (e.g., a room, an office). The computing device 120 and the telephone device 115 are associated with one another and the location.

When a user 105 checks into a hotel, the computing device 120 and the telephone device 115 are associated with the user 105 and the user's 105 reservation. The computing device 120 has a user interface that displays available services and configurable guest preferences. The user 105 can select a service or preference and the selection is sent via the internal network 125 to the webportal 130. If the selection relates to telephone calls, webportal 130 sends the selection to telephone module 140. Telephone module 140 establishes a connection over network 150 with telephone device 115, the telephone associated with the computing device 120 that sent the selection. Based on the selection, telephone module 140 connects telephone device 115 with a second telephone device 160 over network 150. If the selection relates to information requests, webportal 130 sends the selection to information storage module 135. Based on the selection, information storage module 135 retrieves information from its memory and sends it to webportal 130. Webportal 130 transmits the information over internal network 125 for display on computing device 120. If the selection relates to setting guest preferences, webportal 130 sends the selection to information storage module 135. Information storage module stores the guest preference in its memory.

For example, the guest 105, Joe Bloggs, checks into the hotel and finds a thin client computer 120 and a telephone 115 in his hotel room. He selects the telephone option from a menu on the thin client computer 120, types in a telephone number, and uses the mouse to click on a dialing icon. Clicking on the dialing icon sends a telephone call request from thin client computer 120 to telephone module 140. Telephone module 140 establishes a connection with the telephone 115 based on its association with computing device 120. The telephone 115 in Joe's hotel room starts to ring. Joe answers the telephone 115 by picking up a handset or pressing a line button. Telephone module 140 then dials the telephone number to establish a connection between the telephone 115 and a second telephone 160 over network 150. In this example, Joe is calling another hotel guest and the second telephone 160 is located within the same hotel. In another example, Joe is calling a friend in another city and the second telephone 160 is external to the hotel.

In another example, guest Matthew Diamond checks into the hotel. Matthew needs to pick up his Boston Red Sox tickets from will call, but he cannot remember what time the game starts. He clicks on the “Sports & Entertainment” section on the personal computer 120, and a request for sports and entertainment information is sent over the hotel's network 125 to the webportal 130. That night's game time is retrieved from information storage module 135 and sent back for display on the personal computer 120.

As another example, guest Julianne Moviestar arrives at the hotel after a long day on the movie set. Hoping a massage will help her relax, she clicks on the “Health, Fitness & Spa” section on computing device 120, and a request for information on the hotel's fitness center and spa is sent over internal network 125 to webportal 130. Types of massages and facials are retrieved from information storage module 135 and sent back for display on computing device 120.

In another example, guest Joe Millionaire arrives at a hotel for a business conference. He discovers that additional co-workers have signed up for the conference last minute, and the total number of attendees exceeds fire code limitations for the reserved meeting rooms. He clicks on the “Hotel Features” section on computing device 120, and a request for information about hotel meeting rooms is sent over internal network 125 to webportal 130. The dimensions, availability, and fire code limits of various meeting rooms are retrieved from information storage module 135 and sent back for display on computing device 120.

As another example, guest Jane Jetsetter is a frequent guest at a hotel. On January 1, she checks into the hotel before leaving for Reykjavik the following day. She sets the weather forecast location to Reykjavik on the computing device 120. Computing device 120 sends the location over internal network 125 to the webportal 130. The webportal 130 sends the location to information storage module 135 for storage. The webportal 130 also sends the location to a third-party server (not shown), which retrieves the weather forecast information for the location and sends it to the webportal 130. The webportal transmits the weather forecast information over internal network 125 to the computing device 120, and the weather forecast window on computing device 120 is updated to reflect the weather forecast in Reykjavik.

One week later, Jane returns to the hotel, but she plans on flying to St. Petersburg the next day. Upon her check-in, computing device 120 sends an inquiry regarding Jane's preferences over internal network 125 and webportal 130 to information storage module 135. Based on the inquiry, information storage module 135 sends Jane's preferences, including the weather forecast location she had chosen during her last stay, via webportal 130 and internal network 125 to computing device 120. The information storage module 135 also transmits Jane's weather forecast location preference to the third-party server, and the server transmits the weather forecast for the location via webportal 130 and internal network 125 to the computing device 120. The weather forecast window on computing device 120 displays the weather forecast for Reykjavik. Jane notices the setting and changes the weather forecast location preference to St. Petersburg on the computing device 120. Computing device 120 sends the location over internal network 125 to the webportal 130. The webportal 130 sends the location to the information storage module 135 for storage and the third-party server. The third-party server retrieves the weather forecast for St. Petersburg and transmits it via webportal 130 and internal network 125 to the computing device 120. The weather forecast window on computing device 120 is updated to reflect the weather forecast in St. Petersburg.

In some examples, the user 105 selects services or sets preferences through the computing device 120 by touching parts of a touchscreen, pressing alphanumeric keys on a keyboard, and/or pointing and clicking with a mouse. The user 105 can, for example, utilize other inputs methods to select services and/or set preferences (e.g., voice input, handwriting recognition).

In some examples, when user 105 checks out of a hotel, the computing device 120 and the telephone device 115 are no longer associated with user 105. Any information on the computing device 120 can be, for example, removed when the user 105 is no longer associated with the temporary facility (e.g., hotel, hospital).

In some examples, when user 105 checks out of the hotel, guest preferences remain stored on information storage module 135. For example, the user 105 sets his/her weather location preference utilizing the user interface. The weather location preference can be, for example, stored on the information storage module 135. The next time that the user 105 stays at the temporary facility (e.g., hotel, airport lounge), the weather location preferences can be, for example, retrieved from the information storage module 135 and utilized by the user interface to display the weather for the location in the weather location preferences.

In some examples, the network 150 is an Internet protocol (IP) network, a voice over Internet protocol (VoIP) network, an Internetwork packet exchange (IPX) network, a private branch exchange (PBX) network, a public switched telephone network (PSTN), a packet based network, and/or a circuit based network.

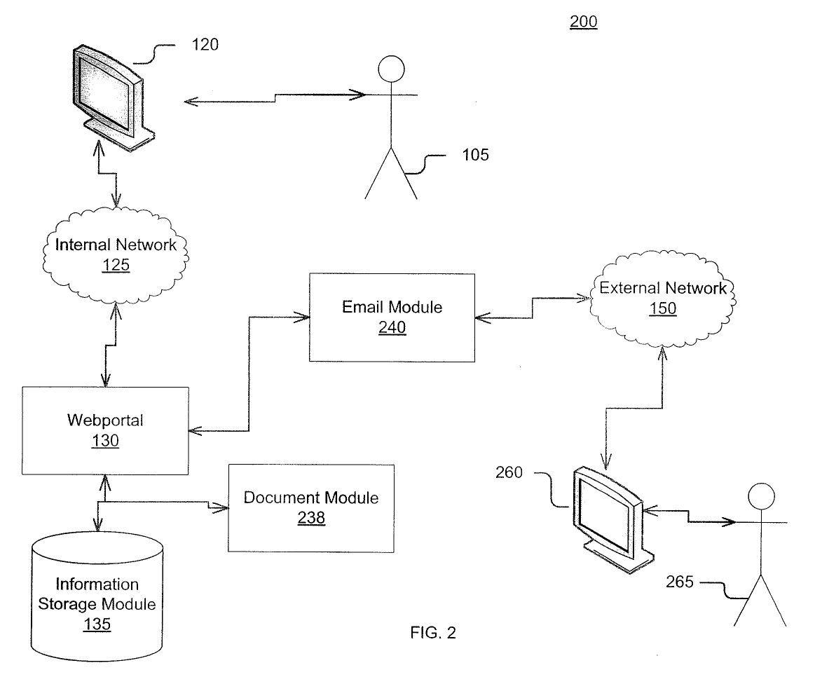

FIG. 2 is a functional block diagram of an exemplary system 200 illustrating electronic messaging and document storage, retrieval, and transmittal functions. The system 200 includes a computing device 120, an internal network 125, a webportal 130, an information storage module 135, a document module 237, an e-mail module 240 associated with the computing device 120, an external network 150, and a second computing device 120.

When the user 105 checks into a hotel, an e-mail address associated with the hotel, user 105, and user's 105 hotel room is created and assigned to user 105. The computing device 120 has a user interface that displays available services. The user 105 selects a service and the selection is sent over internal network 125 to webportal 130. If the selection is related to e-mail, the webportal 130 transmits the selection to the e-mail module 240. The e-mail module 240 sends received messages back to the computing device 120 and/or transmits messages over external network 150 to a second computing device 150. If the selection relates to document processing, the webportal 130 transmits the selection to the document module 238. The document module 238 saves the document and/or transmits the document to e-mail module 240 for attachment to an electronic message. If the selection relates to information requests, the webportal 130 transmits the selection to information storage module 135. Information is retrieved from information storage module 135, transmitted over webportal 130 and internal network 125, and displayed on computing device 120.

For example, an airline loses Bill Alwaysconnected's luggage, including his laptop and PDA. Ever prepared, Bill has sent a copy of the company presentation to his business e-mail account. He opens the e-mail menu on computing device 120 and selects the portal for third-party e-mail accounts. He enters his business e-mail address and password into computing device 120. A request for e-mail access is sent to e-mail module 240, and e-mail module 240 communicates with the server corresponding to the business e-mail account (not shown). E-mail module 240 retrieves messages stored in the business e-mail account and transmits them to computing device 120.

Relieved, Bill finds the electronic message with the presentation as an attachment. He selects the “download attachment” option on computing device 120, and the document is transmitted over internal network 125 and webportal 130 to be saved in document module 238. He then discovers the presentation needs a few minor alterations. After rearranging a few slides and adjusting fonts, he selects the “save document” option on computing device 120. The modified document is transmitted and saved on document module 238. Realizing his co-presenter's luggage was similarly lost by the airline, Bill decides to send the presentation to his co-presenter. Bill selects the “compose message” option on computing device 120. He enters his co-presenter's e-mail address, types a message explaining the changes, attaches the revised presentation, and hits a send button. Document module 238 sends the stored presentation to e-mail module 240. E-mail module 240 attaches the presentation to the electronic message and sends the entire message to the server corresponding to the co-presenter's e-mail address (not shown).

Bill then realizes his luggage also contained his ticket for a flight the following evening, after the presentation. He finds the electronic message in his account that contains his boarding pass. By selecting the “save document” option, he saves his boarding pass onto document module 238. Bill selects the “print document” option, and document module 238 sends the document to the hotel's business center with a request to print the document on a public printer (not shown). Bill retrieves his boarding pass from the business center and tucks it into his wallet.

As another example, a group of friends check into a hotel for their post-bar exam celebration trip. Jennifer Eagle and Katie Shark are staying in rooms #478 and #497, respectively. Jennifer wants to let Katie know that dinner plans have changed, but she can only remember Katie's room number. She sits down at computing device 120 and opens the e-mail account associated with her hotel room. Computing device 120 sends an access request through to webportal 130. Messages are retrieved from e-mail module 240 associated with room 478, transmitted over internal network 125, and displayed on computing device 120. Jennifer selects the “compose message” option, enters “Room 497” into the e-mail address, types a quick message about the restaurant, and selects the “send” option. The message is relayed over the network to the e-mail module associated with the computing device in room #497 (not shown). When Katie arrives in her hotel room, the computing device there notifies her that her account has received a new message.

In some examples, when user 105 checks out of the hotel, the e-mail address associated with the hotel, user 105, and user's 105 hotel room is deleted from computing device 120. The email address can be, for example, deleted from the computer device 120 and saved by the information storage module 135. An advantage is that the computing device 120 does not retain any personal information about the user 105 which provides increased security for the user's personal information.

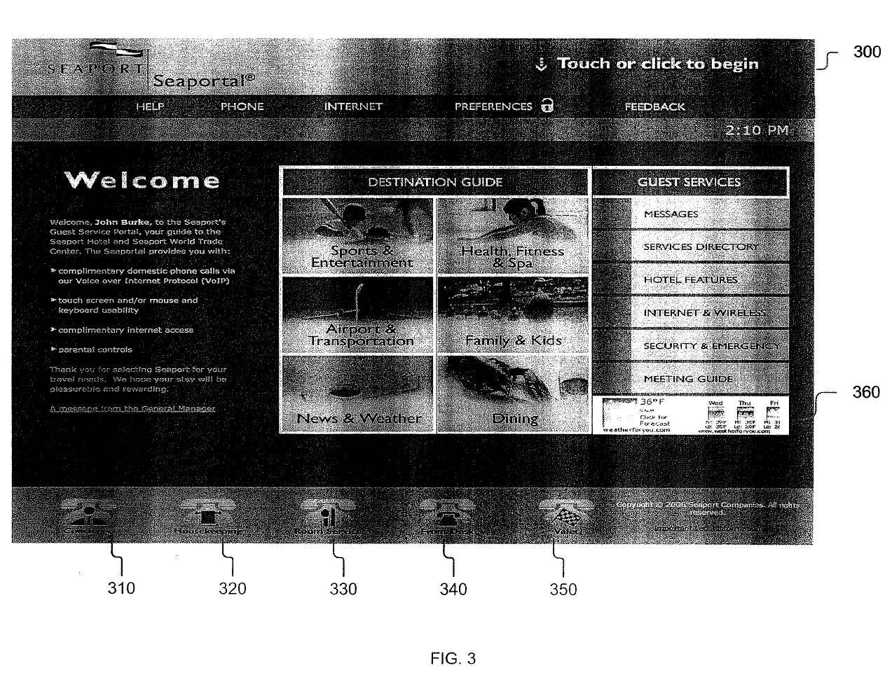

FIG. 3 is a welcome screenshot 300 of an exemplary user interface utilized on the computing device 120 of FIG. 1. The computing device 120 can default to welcome screen shot 300 when user 105 checks into the hotel room. Welcome screenshot 300 includes the local weather forecast in weather forecast window 360. User interface 300 also includes links to services such as concierge 310, housekeeping 320, room service 330, front desk 340, and valet 350. When user 105 selects a link for a service (e.g., the concierge 310), a telephone call request to the service facility can be automatically initiated.

For example, Tom Traveler's flight was severely delayed and he arrives at the hotel in the late evening. Tired and famished, Tom lugs his suitcase into his hotel room and clicks on room service link 330 on computing device 120. Telephone device 115 in his room rings as system 100 establishes a connection between telephone device 115 and network 150. Tom picks up the telephone device's 115 handset, and the telephone module 140 connects him to the room service department. Tom then orders a hamburger.

Tom then unpacks his suitcase and discovers he has forgotten to pack a razor. Tom returns to computing device 120 and selects the concierge link 310. Telephone device 115 rings, Tom answers the telephone, and he is connected to the concierge department. Tom then requests that two razors be sent to his hotel room.

As another example, Tom checks into a hotel, but it is his third stay at the hotel. Guest preferences from his previous stays have been stored in the information storage module 135 of FIG. 1, and upon Tom's arrival, they are transmitted to computing device 120 in Tom's hotel room. Weather forecast window 360 on computing device 120 thus reflects the weather preference Tom saved during his last visit to the hotel (in this example, New York City)

In another example, welcome screenshot 300 is personalized by extracting user's 105 information from a property management system. For example, upon the user's 105 check-in, the computing device 120 sends an inquiry over internal network 125 to the property management system (not shown). The property management system retrieves the name of the user 105 staying in the hotel room associated with the computing device 120 and sends it to the webportal 130. The webportal 130 transmits the name over internal network 125 to the computing device 120. The computing device 120 uses the name to personalize the welcome screen so it greets the user 105 by name.

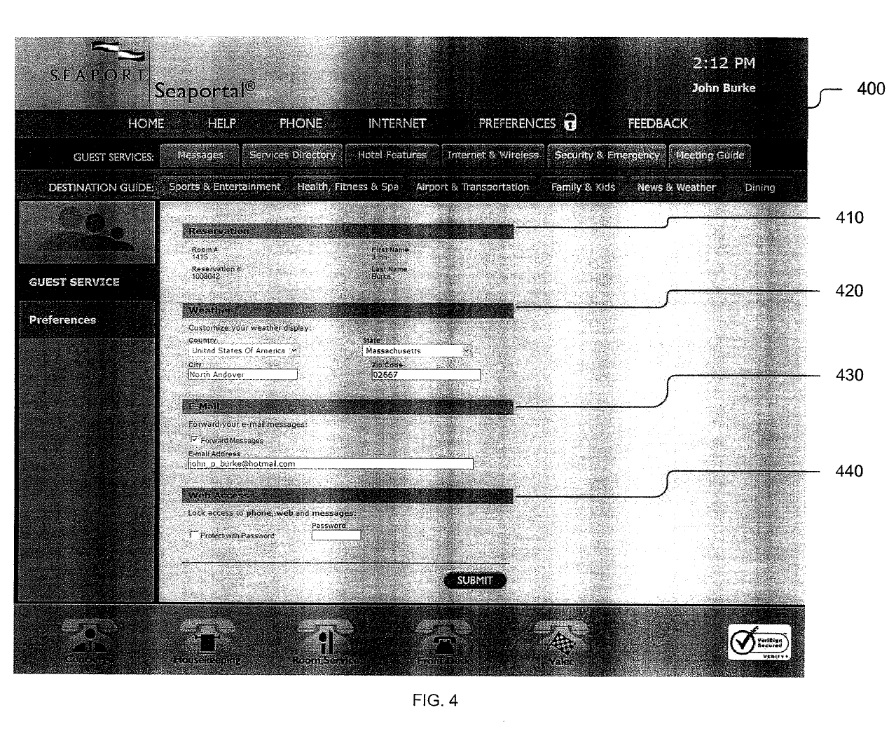

FIG. 4 is a preferences screenshot 400 of an exemplary user interface utilized on the computing device 120 of FIG. 1. From preferences screenshot 400, the user 105 can view and/or change guest preferences that are stored on information module 135. Reservation area 410 shows information related to user's 105 reservation such as name, room number, and reservation number.

Through weather area 420, the user 105 chooses the location for which weather forecasts will be displayed in, for example, weather forecast window 360 of FIG. 3. The location can be specified by country, city, state, and/or zip code. Upon the user's 105 initial stay at a hotel, the location can default to the hotel's location. Through preferences screenshot 400, the user 105 can change the guest preference to obtain weather information for other locations. For example, guest Sally Jones is leaving for Chicago tomorrow and wants to dress appropriately for the weather. She enters “Chicago, Ill.” into weather area 420 and submits the request. Weather information is retrieved from a third party server (not shown) and displayed on computing device 120 in weather forecast window 360.

Through message forwarding service area 430, the user 105 can have electronic messages sent to the hotel forwarded to another e-mail address after he checks out. The user 105 activates the message forwarding service by selecting the service, providing an e-mail address, and submitting the guest preference to system 100. The service's selection and e-mail address are stored in information storage module 135. The user 105 can provide a personal e-mail address, a work e-mail address, and/or an e-mail address on a PDA.

Through access control area 440, user 105 can exert security and/or parental control. User 105 activates access control by selecting the service, providing a password, and submitting the guest preference to system 100. The service's selection and password are stored in information storage module 135. When the service is activated, web, phone, and/or message services are grayed out until the password is correctly provided.

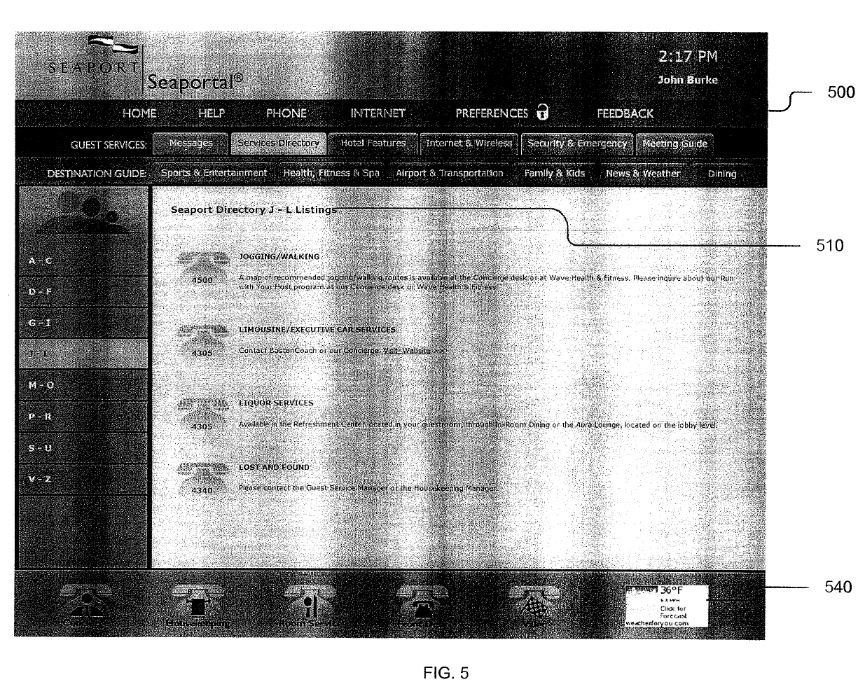

FIG. 5 is a services directory screenshot 500 of an exemplary user interface utilized on the computing device 120 of FIG. 1. Services directory screenshot 500 displays the categories of information the user 105 can access. The user 105 selects a type of information to access from computing device 120, and the information is retrieved from information storage module 135. Examples of information user 105 can access include service directories, hotel features, Internet and wireless capabilities, security and emergency information, availability and dimensions of meeting rooms, local sporting events, entertainment options, spa treatments and prices, flight arrival times, transportation options to airports, and/or dining options.

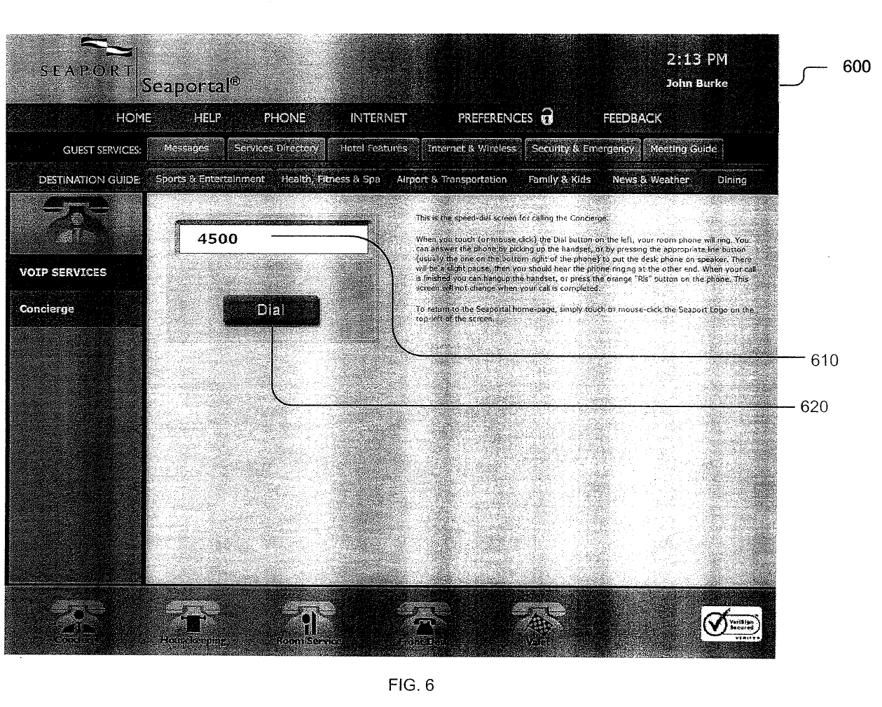

FIG. 6 is a speed-dial screenshot 600 of an exemplary user interface utilized on the computing device 120 of FIG. 1. Speed-dial screenshot 600 appears, for example, when the concierge service link 310 of FIG. 3 is selected. Contact information field 610 is automatically filled with the concierge service's telephone number. The user 105 can select dial button 620 to initiate a telephone call request. Alternatively, when the user 105 clicks on concierge service link 310, speed-dial screenshot 600 appears and a telephone call request is automatically initiated. In other examples, links to other services generate other user interfaces with corresponding telephone numbers automatically filled in.

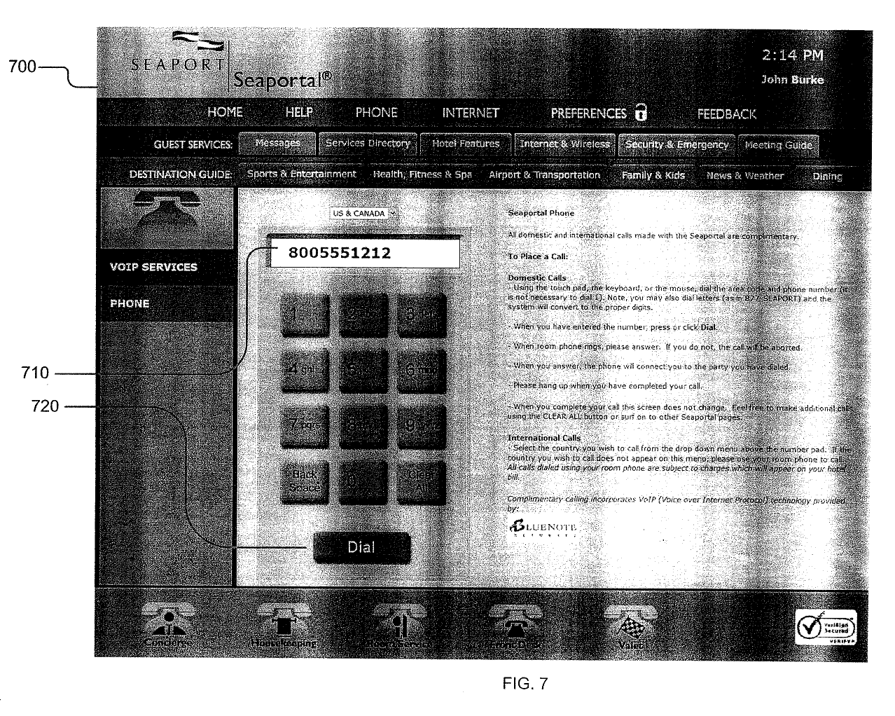

FIG. 7 is a telephone screenshot 700 of an exemplary user interface utilized on the computing device 120 of FIG. 1. Telephone screenshot 700 appears when user 105 selects the telephone option on computing device 120. User 105 selects the country she/he will call using the drop-down menu above telephone number field 710. User 105 enters the telephone number in telephone number field 710 and selects dial button 720 to initiate a telephone call request.

In some examples, the telephone number is entered by pressing alphanumeric keys on a keyboard, touching portions of the touchscreen, and/or selecting icons using a mouse. In another example, if a letter is entered in telephone number field 710 (e.g., via cut and paste events), it is automatically changed to the corresponding number.

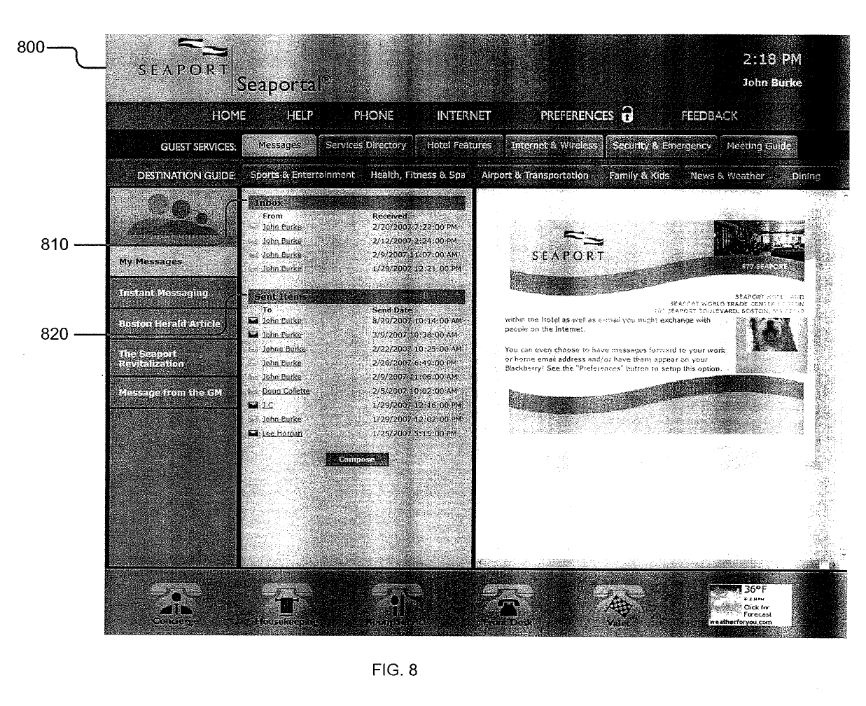

FIG. 8 is an electronic messages screenshot 800 of an exemplary user interface utilized on the computing device 120 on FIG. 1. Electronic messages screenshot 800 appears, for example, when the user 105 selects the messages option on computing device 120. Inbox 810 displays messages that have been received at the e-mail address assigned to user 105. Sent Items 820 displays messages user 105 has sent. User 105 can also select an instant messaging service.

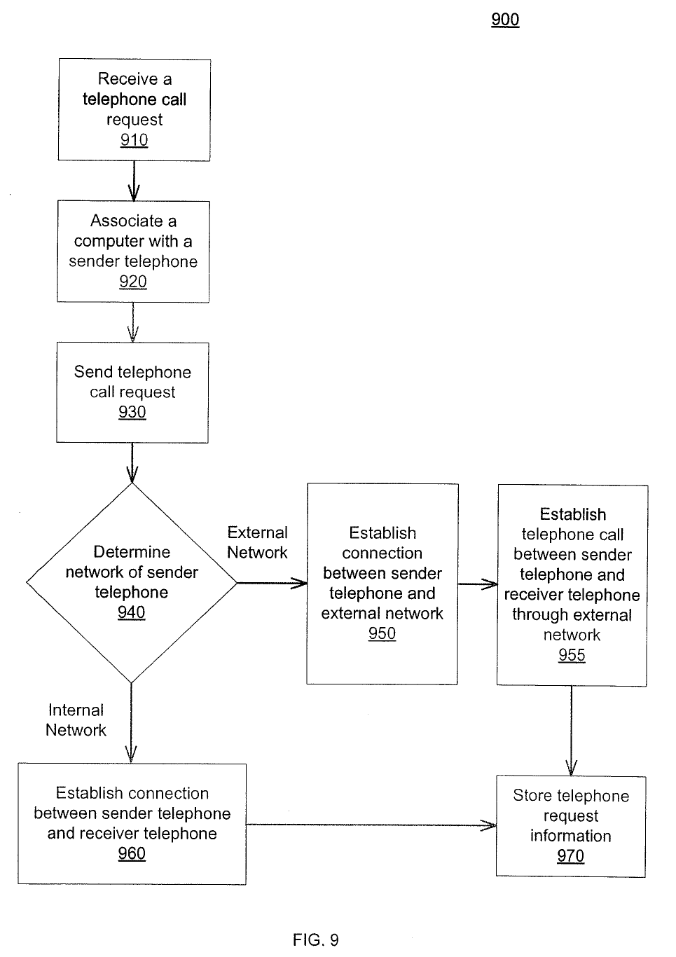

FIG. 9 is an exemplary flowchart 900 of processing telephone call requests through the system 100 of FIG. 1. The user 105 can initiate a telephone call request from computing device 120. Thus, computing device 120 receives (910) the telephone call request. The computing device 120 is then associated with the telephone that sent the request, telephone device 115 (920). The telephone call request is sent (930), and the network of the sender telephone is determined (940). If the network of the sender telephone is determined to be an internal network, a connection is established (950) between the sender telephone and the external network. A telephone call between the sender telephone and receiver telephone is then established (955) through the external network. If the network of the sender telephone is an external network, a connection is established (960) between the sender telephone and receiver telephone. In either case, after the connection is established between the sender telephone and receiver telephone, the telephone request information is stored (970).

For example, the internal network 150 of FIG. 1 is an IP network, telephone device 115 is connected to the IP network, and the telephone call request involves a telephone number outside of the hotel. As telephone device 115 is connected to internal network 150, telephone module 140 establishes (950) a connection between telephone device 115 and an external network, e.g. a PSTN network, so that telephone device 115 can be connected to telephone device 165. Telephone module 140 then establishes (955) a connection between telephone device 115 and telephone device 165 through external network 150.

As another example, the internal network 150 of FIG. 1 is a PBX network, telephone device 115 is connected to the PSTN network through a trunk line, and the telephone call request involves a telephone number outside of the hotel. Because telephone device 115 is already connected to an external network, telephone module 140 can establish (960) a connection between telephone device 115 and another telephone on the PSTN network, such as telephone device 165.

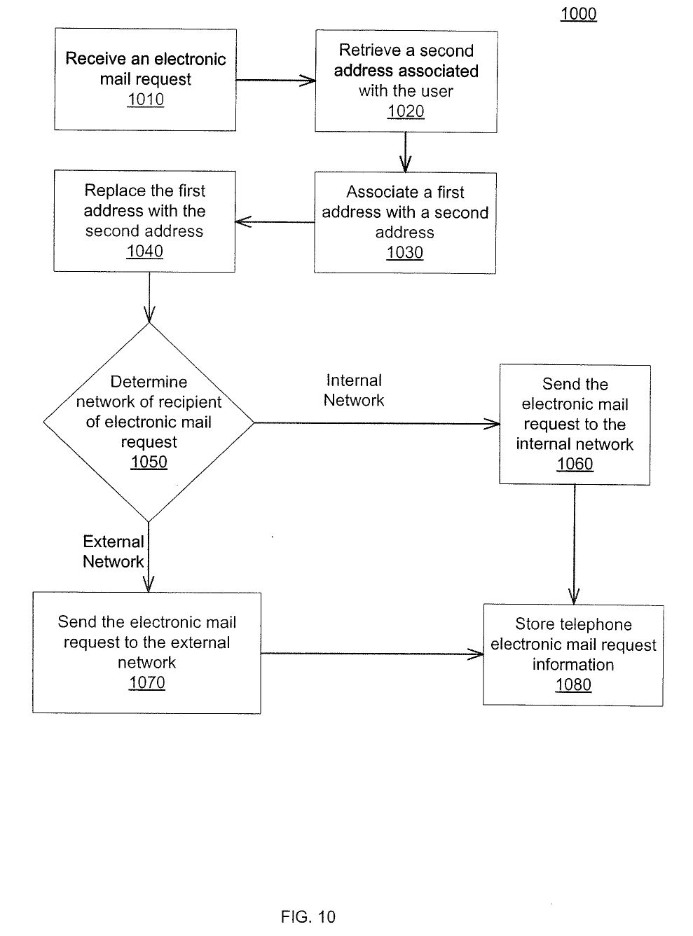

FIG. 10 is an exemplary flowchart 1000 of processing electronic mail requests through the system 200 of FIG. 2. An e-mail module 240 receives (1010) an electronic mail request. The e-mail module 240 retrieves (1020) a second e-mail address associated with the user from information storage module 135. The second e-mail address is associated (1030) with a first e-mail address. The first e-mail address is replaced (1040) with the second e-mail address. The network of the recipient of the electronic mail request is determined (1050). The network is the internal network of, for example, the hotel, the electronic mail request is sent (1060) to the internal network and telephone electronic mail request information is stored (1080) in information storage module 135. If the network is an external network, the electronic mail request is sent (1070) to the external network and telephone electronic mail request information is stored (1080) in the information storage module 135.

For example, before guest Gus checks out of the hotel, he decides to have his electronic messages at the hotel forwarded to his personal account. He activates the message forwarding service and provides an alternative e-mail address. The activation information and e-mail address are stored in information storage module 135. Later on, a hotel e-mail module receives (1010) an electronic message with the e-mail address assigned to Gus during his stay. Information storage module 135 is scanned for Gus's activation information, and the alternative e-mail address is retrieved (1020). The alternative e-mail address and Gus's hotel e-mail address are associated (1030) with one another. The hotel e-mail module then strips Gus's hotel e-mail address off the received electronic message and replaces (1040) it with the alternative e-mail address. The modified message is then sent (1060 or 1070) to the network corresponding to the alternative e-mail address, and the associated e-mail addresses are stored (1080) together in information storage module 135.

In other examples, guest Bob Businessman composes an electronic message from the e-mail account created in association with his reservation at a hotel. Bob has already activated the message forwarding service and provided his business e-mail address (in this example, bob@somefakebusinessname.com) as an alternative account. He hits a “send” option. The e-mail module 240 associated with the computing device 120 in his hotel room receives (1010) the electronic mail request to send the message. The e-mail module 240 retrieves (1020) Bob's business e-mail address from the information storage module 135 and associates (1030) the business e-mail address with Bob's hotel e-mail address. The e-mail module 240 replaces (1040) the hotel e-mail address of the electronic message with the provided business e-mail address. Then, it is determined (1050) whether the recipient of the electronic mail request is internal or external to the hotel, and the electronic message is routed (1060 or 1070) to the appropriate network.

In other examples, guest Beth Businesswoman composes an electronic message from the e-mail account created in association with her reservation at a hotel. Beth has already activated the message forwarding service and provided her business e-mail address (in this example, beth@fakebusinessname.com) as an alternative account. She hits a “send” option. The e-mail module 240 associated with the computing device 120 in her hotel room receives (1010) the electronic mail request to send the message. The e-mail module 240 retrieves (1020) Bob's business e-mail address from the information storage module 135 and associates (1030) the business e-mail address with Bob's hotel e-mail address. The e-mail module 240 retains the hotel e-mail address as the originating address of the electronic message, but changes the “reply-to” address from the hotel e-mail address to the provided business e-mail address. Then, it is determined whether the recipient of the electronic mail request is internal or external to the hotel, and the electronic message is routed to the appropriate network.

In some examples, the e-mail module 240 removes the first email address and replaces the first email address with the second email address. The e-mail module 240 can, for example, retain the first email address in a From field and replace the second email address into a Reply field. For example, the From and the Reply include hoteluserABC23234@somefakehotel.com and the From field is retained and the Reply field is replaced with Bob@somefakebusiness.com.

In other examples, the email address associated with the hotel or other temporarily facility is uniquely associated to the guest. For example, at Grand Hotel, Bob Businessman was assigned the email address of hotelguest34242@grandhotelfake.com. The assignment of this email address was made during Bob's first registration at Grand Hotel. No other guests at Grand Hotel will receive this email address. In other words, Bob will be the only guest utilizing this email address. All replies to this email address, hotelguest34242@grandhotelfake.com, can be, for example, forwarded to the forwarding email address (in this example, bob@somefakebusiness.com) which Bob has set in his preferences. For example, the email module 240 receives an email message addressed to hotelguest34242@grandhotelfake.com and determines that Bob, who is associated with the email address, is not currently checked into the hotel and forwards the email message to Bob's forwarding email address, bob@somefakebusiness.com.

In some examples, the email module 240 forwards received email messages and stores a copy of received email message. The preferences for saving and/or forwarding email messages can be, for example, stored by the information storage module 135. The user interface can, for example, provide preference options for email preferences for the user which allows him/her to select when, where, which, and/or how to save and/or forward email messages. In other examples, the email module 240 includes email rules which provide information for when, where, which, and/or how to save and/or forward email messages. For examples, Bob Businessman sets a rule that only email messages from a person in his contact list (e.g., uploaded from his PDA, includes email addresses that he has sent message to from the hotel) are to be forwarded to his business email address. As another example, Betty Businesswomen sets a rule that email messages are only to be forwarded to her business email address while she is checked into the hotel and for three days after she checks out of the hotel.

In other examples, customized maps of system 100 or system 200 can be requested, received, and/or displayed. A customized map can be based on information about computing devices, information about telephones, information inputted by guests, and/or information inputted by the hospitality system's administrator.

The above-described systems and methods can be implemented in digital electronic circuitry, in computer hardware, firmware, and/or software. The implementation can be as a computer program product (i.e., a computer program tangibly embodied in an information carrier). The implementation can, for example, be in a machine-readable storage device, for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by and an apparatus can be implemented as special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can include, can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device. The display device can, for example, be a cathode ray tube (CRT) and/or a liquid crystal display (LCD) monitor. The interaction with a user can, for example, be a display of information to the user and a keyboard and a pointing device (e.g., a mouse or a trackball) by which the user can provide input to the computer (e.g., interact with a user interface element). Other kinds of devices can be used to provide for interaction with a user. Other devices can, for example, be feedback provided to the user in any form of sensory feedback (e.g., visual feedback, auditory feedback, or tactile feedback). Input from the user can, for example, be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

Packet-based networks can include, for example, the Internet, a carrier Internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, Bluetooth, code-division multiple access (CDMA) network, time division multiple access (TDMA) network, global system for mobile communications (GSM) network), and/or other circuit-based networks.

The computing device can include, for example, a thin client device, a touch screen computing device, a computer, a computer with a browser device, a telephone, an IP phone, a mobile wireless computing device (e.g., cellular phone, personal digital assistant (PDA) device, laptop computer, electronic message device), and/or other communication devices. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). The mobile computing device includes, for example, a personal digital assistant (PDA).

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

We claim:

1. A computerized method for guest communication and information delivery, the method comprising:
providing a user interface for accessing information by a guest, the information being based on a location associated with a computing device;
providing the user interface for initiating a telephone call from a first telephone device based on a telephone call request from the computing device associated with a guest, the first telephone device being separate from the computing device and associated with the guest; and
providing the user interface for sending a modified electronic message to a first network, the modified electronic message comprising a modification which comprises replacing a first electronic message address with a second electronic message address.

2. The method of claim 1, wherein the accessing the information is through a web portal.

3. The method of claim 1, wherein the first electronic message address is associated with a hotel, the second electronic message address is associated with a business which is different from the hotel, and the guest is associated with the business and a room in the hotel.

4. The method of claim 1, wherein the sending the modified electronic message further comprises retrieving the second electronic message address from an information storage module based on information associated with the guest.

5. The method of claim 1 further comprises creating the first electronic message address for the guest based on a location associated with a computing device and information associated with the guest, the first electronic message address being assigned solely to the guest.

6. The method of claim 1 further comprising:
receiving, at an email module associated with the computing device, a reply to the modified electronic message, the reply comprises the first electronic mail address; and
associating the reply to the second electronic mail address based on an assignment of the first electronic mail address to the guest.

7. The method of claim 6 further comprises forwarding, at the email module, the reply to the second electronic mail address based on information associated with the guest.

8. The method of claim 1, wherein the initiating the telephone call further comprising:
associating the computing device to the first telephone device based on location information associated with the computing device and location information associated with the first telephone device; and
sending the telephone call request to a second network associated with the first telephone device.

9. The method of claim 8 further comprises initiating the telephone call between the first telephone device and a second telephone device based on the telephone call request from the computing device.

10. The method of claim 8, wherein the location information associated with the computing device comprises a first room assignment in a hotel and the location information associated with the first telephone device comprises a second room assignment, which is the same as the first room assignment, in the hotel.

11. The method of claim 1, wherein the information is further being based on one or more guest preferences.

12. The method of claim 11, wherein the one or more guest preferences include contact information, email information, electronic message address, web access information, weather information, security information, dining information, visitor information, emergency information, default appointments, telephone number, geographic information, or any combination thereof.

13. The method of claim 1 further comprises storing, at an information storage module, one or more guest preferences associated with the guest.

14. The method of claim 1, wherein the information comprises help information, phone information, web information, preference information, destination information, guest service information, message information, service directory information, hotel feature information, Internet information, wireless information, security information, emergency information, meeting guide information, weather information, or any combination thereof.

15. The method of claim 1 further comprises locating the computing device in a hotel room, a dorm room, a rental unit, a temporary housing unit, a patient hospital room, or any combination thereof.

16. The method of claim 1, wherein the computing device and the first telephone device are in the same physical location.

17. The method of claim 1 further comprises removing information associated with the guest from the computing device.

18. The method of claim 1 further comprises displaying a map which is customized based on the location of the computing device, the location of the first telephone device, information inputted by the guest, information inputted by an entity administrating the web portal, or any combination thereof.

19. A computer program product, tangibly embodied in a computer or a removable storage device, the computer program product including instructions being operable to cause a data processing apparatus to:
provide a user interface for accessing information by a guest, the information being based on a location associated with a computing device;
provide the user interface for initiating a telephone call from a first telephone device based on a telephone call request from the computing device associated with a guest, the first telephone device being separate from the computing device and associated with the guest; and
provide the user interface for sending a modified electronic message to a first network, the modified electronic message comprises a modification which comprises replacing a first electronic message address with a second electronic message address.

20. A system for guest communication and information delivery, the system comprising,
a user interface configured to:
provide for accessing information by a guest, the information being based on a location associated with a computing device;
provide for initiating a telephone call from a first telephone device based on a telephone call request from the guest, the first telephone device being separate from the computing device and associated with the guest; and
provide for sending a modified electronic message to a first network, the modified electronic message comprises a modification which comprises replacing a first electronic message address with a second electronic message address.

21. The system of claim 20, wherein the computing device is associated with the first telephone device, the first telephone device is associated with the guest, and the guest is associated with a room.

22. The system of claim 20, wherein the computing device comprises a thin client computing device, a touch screen computing device, a mobile wireless computing device, or any combination thereof.

23. The system of claim 20 further comprises a document module configured to receive a document, edit the document, transmit the document, store the document, or any combination thereof.

24. The system of claim 20, wherein the telephone call is established through an Internet protocol (IP) network, a voice over Internet protocol (VoIP) network, a private branch exchange (PBX) network, a public switched telephone network (PSTN), or any combination thereof.

25. A system for guest communication and information delivery, the system comprising:
a means for providing for information access by a guest, the information being based on a location associated with a computing device;
a means for providing for initiation of a telephone call from a first telephone device based on a telephone call request from the guest, the first telephone device being separate from the computing device and associated with the guest; and
a means for providing for sending of a modified electronic message to a first network, the modified electronic message comprises a modification which comprises replacing a first electronic message address with a second electronic message address.
